(19) United States
(12) Patent Application Publication
(10) Pub. No.: US 2015/0344772 A1
(43) Pub. Date: Dec. 3, 2015

(54) WELL TREATMENT

(71) Applicant: SCHLUMBERGER TECHNOLOGY CORPORATION, Sugar Land, TX (US)

(72) Inventors: Nicolas Droger, Novosibirsk (RU); Irina Alexandrovna Lomovskaya, Novosibirsk (RU); Diankui Fu, Novosibirsk (RU)

(73) Assignee: SCHLUMBERGER TECHNOLOGY CORPORATION, Sugar Land, TX (US)

(21) Appl. No.: 14/292,339

(22) Filed: May 30, 2014

(51) Int. Cl. C09K 8/80; E21B 43/267

(52) U.S. Cl. CPC C09K 8/805; E21B 43/267

(57) ABSTRACT

A method to treat a subterranean formation penetrated by a wellbore, comprising: providing a treatment slurry comprising a carrying fluid, a solid particulate, an agglomerant and an agglomerant aid; injecting the treatment slurry into a fracture to form a mixture of the solid particulate and the agglomerant; and transforming the mixture into areas that are rich in solid particulate and areas that are substantially free of solid particulate. Also disclosed are a composition comprised of the carrying fluid, solid particulate, agglomerant and agglomerant aid, as well as a method of designing a well treatment therewith and a system to form conductive channels in a fracture.

### RELATED APPLICATION DATA

None.

### BACKGROUND

The statements in this section merely provide background information related to the present disclosure and may not constitute prior art.

Fracturing is used to increase permeability of subterranean formations. A fracturing fluid is injected into the wellbore passing through the subterranean formation. A propping agent (proppant) is injected into the fracture to maintain the distance between the fracture walls upon closure and, thereby, to provide hydraulic conductivity and improved extraction of extractive fluids, such as oil, gas or water.

Heterogeneous placement of the proppant in clusters can create conductive channels around the proppant clusters. Excessive settling of proppant particles before fracture closure, however, can decrease the conductivity in the fracture.

### SUMMARY

The disclosed subject matter of the application provides methods, compositions, and systems to treat subterranean formations penetrated by a wellbore using a treatment slurry comprising a carrying fluid, a solid particulate, an agglomerant and an agglomerant aid by which non-homogeneous settling may result in areas of solid particle-rich clusters surrounded by substantially solid particle-lean areas.

In some embodiments according to the present disclosure, a method to treat a subterranean formation penetrated by a wellbore comprises providing a treatment slurry stage comprising a carrying fluid, a low aspect ratio solid particulate, a high aspect ratio agglomerant, and a delayed or temporarily inactivated agglomerant aid, such as, for example, a releasable binding liquid; injecting the treatment slurry stage above a fracturing pressure into the formation to distribute a mixture of the solid particulate, the agglomerant and the delayed agglomerant aid in a fracture; activating the agglomerant aid to generate a binding liquid to facilitate agglomeration of the solid particulate with the agglomerant; prior to closure of the fracture, allowing the solid particulate to agglomerate in the fracture for a period of time to form clusters of the solid particulate in the mixture, and to form regions between the clusters that are substantially free of the solid particulate, wherein the formation of the clusters results at least in part from coalescence of the binding liquid; and reducing pressure in the fracture to close the fracture onto the clusters and form interconnected, hydraulically conductive channels between the clusters.

In some embodiments according to the present disclosure, a composition comprises a carrying fluid, a plurality of solid particulates, an agglomerant having an aspect ratio higher than an aspect ratio of the solid particulates, and a delayed agglomerant aid comprising a releasable binding liquid or a precursor of a binding liquid. the composition is capable of transforming via settling from a first state of having a substantially uniform distribution of one or more of the solid particulate, the agglomerant and the agglomerant aid, to a second state comprising clusters rich in the solid particulates and regions that are substantially free of the solid particulates. In embodiments, the composition is capable of transforming via coalescence of the binding liquid from a first state of having a substantially uniform distribution of one or more of the solid particulate, the agglomerant and the agglomerant aid, to a second state comprising clusters rich in the solid particulates and regions that are substantially free of the solid particulates.

In some embodiments according to the present disclosure, a method of designing a treatment comprises considering a fracture dimension; selecting an agglomerant having a dimension comparable to the fracture dimension; selecting a solid particulate having a substantially different settling velocity from the agglomerant; selecting an agglomerant aid to release a binding liquid to facilitate binding of the solid particulate and the agglomerant; and formulating a treatment fluid comprising the solid particulate, the agglomerant and the agglomerant aid such that the binding liquid is capable of coalescing of the in the fracture to form clusters of the solid particulate, and to form regions between the clusters that are substantially free of the solid particulate. In some embodiments, the method may further include injecting the treatment fluid into the fracture.

In some embodiments according to the present disclosure, a system to form conductive channels in a fracture comprises a subterranean fracture having a fracture width; a treatment fluid placed in the fracture above a fracturing pressure and comprising a carrying liquid, an agglomerant having a dimension comparable to the fracture width, a solid particulate having a substantially different settling velocity from the agglomerant and a delayed agglomerant aid to release a binding liquid to facilitate binding of the solid particulate and the agglomerant. In some embodiments, the treatment fluid in the fracture comprises a substantially uniform distribution of the solid particulate, and a heterogeneous distribution of at least one of the agglomerant, the agglomerant aid and an agglomerant aid activator, such that the binding liquid is capable of coalescing in the fracture to form clusters of the solid particulate and regions between the clusters that are substantially free of the solid particulate.

According to some embodiments, the carrying fluid is aqueous and the binding liquid is hydrophobic. In some embodiments, the agglomerant aid comprises a viscoelastic surfactant in a micellar dispersion to viscosify the carrying fluid during the injection and wherein the viscoelastic surfactant is converted to a free fatty acid form in the activation to generate the binding liquid. In some embodiments, the carrying fluid comprises an oil-in-water emulsion and the agglomerant aid is activated by destabilizing the emulsion, e.g., an oil-in-water emulsion stabilized with a surfactant during the injection and destabilized in the fracture by changing a pH of the carrying fluid to activate the agglomerant aid.

According to some embodiments, the activation of the agglomerant aid comprises changing a pH of the carrying fluid, e.g., wherein a pH of the carrying fluid is relatively high during the injection and lowered in the activation by releasing an acid. In some embodiments, the treatment slurry stage comprises an ester wherein an acid is released to activate the agglomerant aid by hydrolysis of the ester, or an encapsulated acid or acid precursor which is released to activate the agglomerant aid, e.g., wax coated citric acid which is released by melting the wax in the fracture to activate the agglomerant aid.

According to some embodiments, the agglomerant has an aspect ratio higher than 6 and the solid particulate has an aspect ratio less than 6. In some embodiments, the agglomerant is a fiber, a flake, a ribbon, a platelet, a rod, or a combination thereof. In some embodiments, the agglomerant is a degradable material. In some embodiments, the agglomerant is selected from the group consisting of polylactic acid, polyester, polycaprolactam, polyamide, polyglycolic acid, polyterephthalate, cellulose, wool, basalt, glass, rubber, sticky fiber, or a combination thereof.

According to some embodiments, the treatment slurry is a proppant-laden hydraulic fracturing fluid and the solid particulate is the proppant.

According to some embodiments, the mixture distributed in the fracture comprises a substantially uniform distribution of one or more of the solid particulate, the agglomerant, the agglomerant aid, and if present, the agglomerant aid activator. In some embodiments, the mixture distributed in the fracture comprises a substantially uniform distribution of the solid particulate, and a heterogeneous distribution of one or more of the agglomerant, the agglomerant aid and, if present, the agglomerant aid activator.

According to some embodiments, the clusters that are rich in solid particulates comprise a matrix of the agglomerant and binding liquid filled with the solid particulates. In some embodiments, the solid particulate is present in the treatment slurry in an amount of less than 22 vol %, based on the total volume of the treatment slurry, and/or the agglomerant is present in the treatment slurry in an amount of less than 5 vol %. In some embodiments, the viscosity of the carrying fluid is from 10 Pa·s to 500 Pa·s at the range of shear rates 0.001-0.1 s⁻¹ when transforming the composition from the first to the second state.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

These and other features and advantages will be better understood by reference to the following detailed description when considered in conjunction with the accompanying drawings.

FIG. 1 schematically illustrates a fracture filled with homogeneously distributed proppant and fibers, according to embodiments of the present disclosure.

FIG. 2 schematically illustrates the fracture of FIG. 1 after the release of a binding liquid from the carrying fluid, according to embodiments of the present disclosure.

FIG. 3 schematically illustrates the fracture of FIG. 2 wherein the binding liquid has an affinity for the fibers, according to embodiments of the present disclosure.

FIG. 4 schematically illustrates the initiation of agglomeration of fibers of FIG. 3, according to embodiments of the present disclosure.

FIG. 5 schematically illustrates the agglomeration of fibers and particles into pillars in the fracture of FIG. 4, according to embodiments of the present disclosure.

FIG. 6 is a photograph showing the initial appearance of an oil-based VES mixture of fibers and 100 mesh sand in a slot according to Example 1, according to embodiments of the disclosure.

FIG. 7 is a photograph of the slot of FIG. 6 after heating for three hours, showing the appearance of small pillars according to embodiments of the disclosure.

FIG. 8 is a photograph showing the initial appearance of an oil-based VES mixture of fibers and 30/50 mesh proppant in a slot according to Example 2, according to embodiments of the disclosure.

FIG. 9 is a photograph of the slot of FIG. 8 after heating for three hours, showing the appearance of pillars, according to embodiments of the disclosure.

### DETAILED DESCRIPTION OF SOME ILLUSTRATIVE EMBODIMENTS

For the purposes of promoting an understanding of the principles of the disclosure, reference will now be made to some illustrative embodiments of the current application.

For the purposes of promoting an understanding of the principles of the disclosure, reference will now be made to some illustrative embodiments of the current application. Like reference numerals used herein refer to like parts in the various drawings. Reference numerals without suffixed letters refer to the part(s) in general; reference numerals with suffixed letters refer to a specific one of the parts.

As used herein, “embodiments” refers to non-limiting examples of the application disclosed herein, whether claimed or not, which may be employed or present alone or in any combination or permutation with one or more other embodiments. Each embodiment disclosed herein should be regarded both as an added feature to be used with one or more other embodiments, as well as an alternative to be used separately or in lieu of one or more other embodiments. It should be understood that no limitation of the scope of the claimed subject matter is thereby intended, any alterations and further modifications in the illustrated embodiments, and any further applications of the principles of the application as illustrated therein as would normally occur to one skilled in the art to which the disclosure relates are contemplated herein.

Moreover, the schematic illustrations and descriptions provided herein are understood to be examples only, and components and operations may be combined or divided, and added or removed, as well as re-ordered in whole or part, unless stated explicitly to the contrary herein. Certain operations illustrated may be implemented by a computer executing a computer program product on a computer readable medium, where the computer program product comprises instructions causing the computer to execute one or more of the operations, or to issue commands to other devices to execute one or more of the operations.

It should be understood that, although a substantial portion of the following detailed description may be provided in the context of oilfield hydraulic fracturing operations, other oilfield operations such as cementing, gravel packing, etc., or even non-oilfield well treatment operations, can utilize and benefit as well from the instant disclosure.

In some embodiments according to the disclosure herein, an in situ method and system are provided for increasing fracture conductivity. By “in situ” is meant that channels of relatively high hydraulic conductivity are formed in a fracture after it has been filled with a generally continuous proppant or other particle concentration. The following discussion refers to proppant as one example of the first solid particle which may be used in the present disclosure, although other types of solid particles are contemplated. The terms proppant and sand are used interchangeably herein.

As used herein, a “hydraulically conductive fracture” is one which has a high conductivity relative to the adjacent formation matrix, whereas the term “conductive channel” refers to both open channels as well as channels filled with a matrix having interstitial spaces for permeation of fluids through the channel, such that the channel has a relatively higher conductivity than adjacent non-channel areas.

The term “continuous” in reference to concentration or other parameter as a function of another variable such as time, for example, means that the concentration or other parameter is an uninterrupted or unbroken function, which may include relatively smooth increases and/or decreases with time, e.g., a smooth rate or concentration of proppant particle introduction into a fracture such that the distribution of the proppant particles is free of repeated discontinuities and/or heterogeneities over the extent of proppant particle filling. In some embodiments, a relatively small step change in a function is considered to be continuous where the change is within +/−10% of the initial function value, or within +/−5% of the initial function value, or within +/−2% of the initial function value, or within +/−1% of the initial function value, or the like over a period of time of 1 minute, 10 seconds, 1 second, or 1 millisecond. The term “repeated” herein refers to an event which occurs more than once in a stage.

Conversely, a parameter as a function of another variable such as time, for example, is “discontinuous” wherever it is not continuous, and in some embodiments, a repeated relatively large step function change is considered to be discontinuous, e.g., where the lower one of the parameter values before and after the step change is less than 80%, or less than 50%, or less than 20%, or less than 10%, or less than 5%, or less than 2% or less than 1%, of the higher one of the parameter values before and after the step change over a period of time of 1 minute, 10 seconds, 1 second, or 1 millisecond.

In embodiments, the conductive channels are formed in situ after placement of the proppant particles in the fracture by differential movement of the proppant particles, e.g., by coalescence of the binding liquid around the agglomerant and/or proppant particles, by gravitational settling and/or fluid movement such as fluid flow initiated by a flowback operation, out of and/or away from an area(s) corresponding to the conductive channel(s) and into or toward spaced-apart areas in which clustering of the proppant particles results in the formation of relatively less conductive areas, which clusters may correspond to pillars between opposing fracture faces upon closure. In embodiments, the movement of the proppant particles may be facilitated by the presence or introduction of an agglomerant aid such as a binding liquid, e.g., a hydrophobic liquid In embodiments; and the movement of the proppant particles may optionally be further facilitated by reduction of the viscosity of the treatment fluid, which may be instantaneous, gradual, or stagewise.

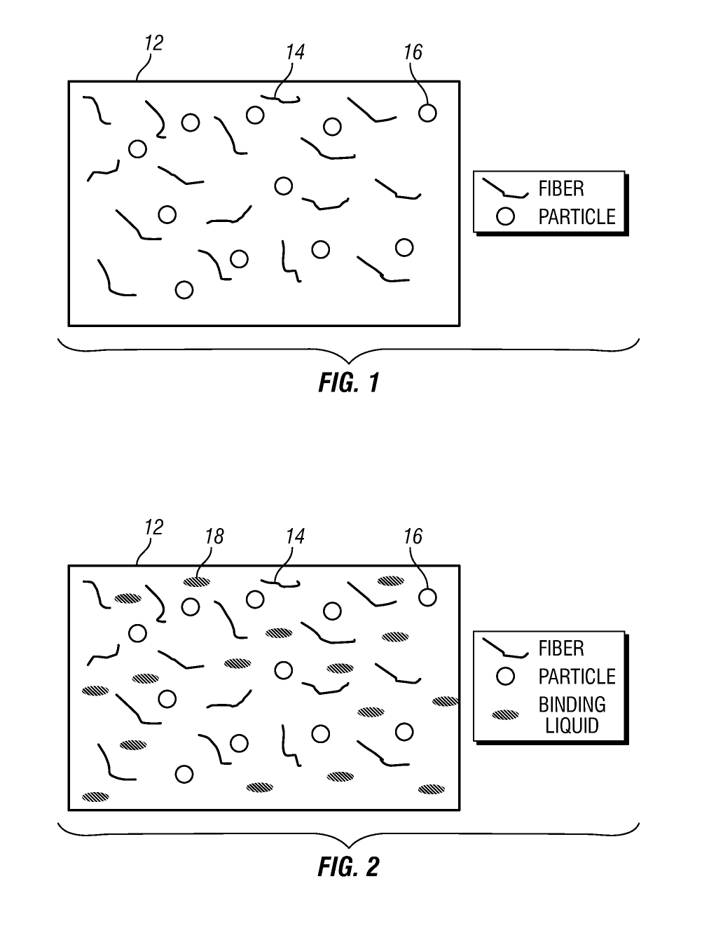

In some embodiments, the method comprises pumping a proppant laden fracturing fluid into a subterranean formation at pressure above a fracturing pressure of the formation. With reference to FIG. 1, in some embodiments a wellbore in communication with a fracture 12 may introduce a fracturing fluid transporting agglomerants such as fiber 14 and solid particle such as proppant 16 into the fracture 12. During the fracturing stage in these embodiments, the fracturing fluid flows radially away from the wellbore to distribute the agglomerants 14 and proppant 16 within the fracture 12.

Following the injection of the fracturing fluid, the well or treatment zone thereof in some embodiments may be shut in or the pressure otherwise sufficiently maintained to keep the fracture 12 from closing while clusters and channels are formed to facilitate conductivity of the fracture after closure as described herein.

The fluid placed in the fracture 12 may include, activate, generate or release a binding liquid 18 as seen in FIG. 2. For example the binding liquid may be hydrophobic and/or otherwise have an affinity for the fibers 14 and/or proppant 16. The binding liquid in some embodiments may promote the agglomeration of the fibers 14 and/or proppant 16, depending on the affinity of the binding liquid for the fibers 14, proppant 16 or both.

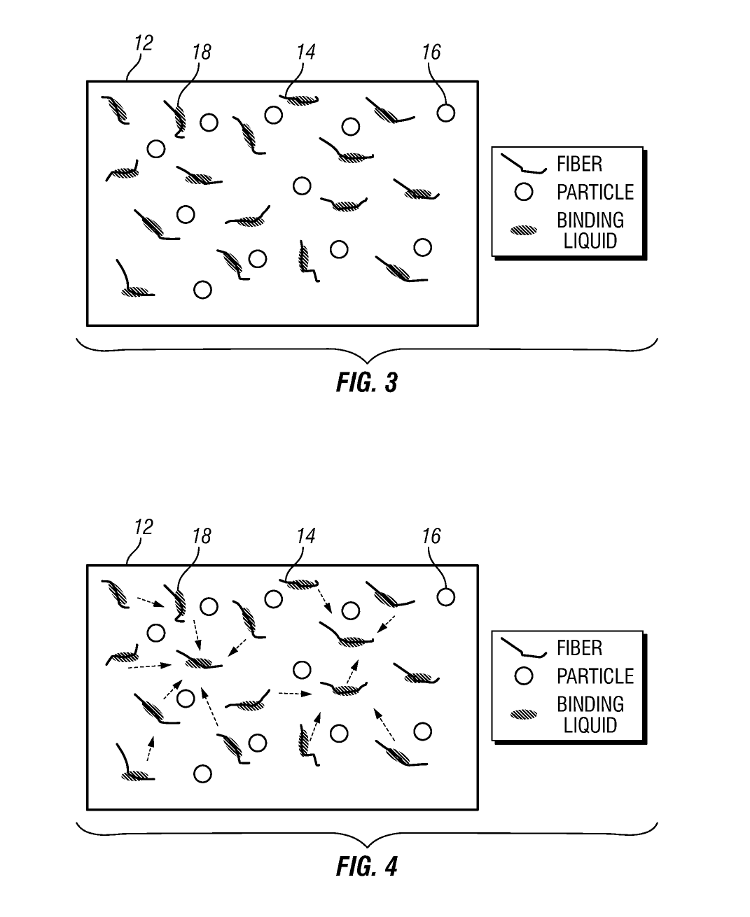

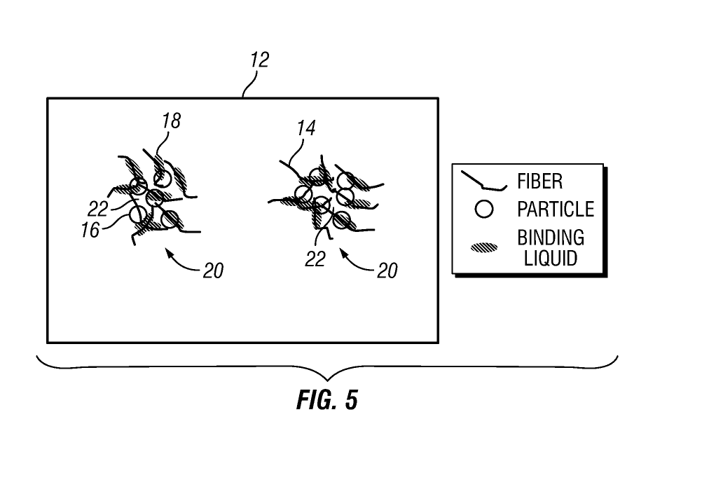

In FIG. 3, the binding liquid 18 is shown as having an affinity for the fibers 14 and preferentially coats, adheres to or otherwise associates with the fibers 14. In FIG. 4, the fiber 14 associated with the binding liquid 18 are drawn toward nearby fiber 14-binding liquid 18 complexes by the tendency of the binding liquid 18 to coalesce and agglomerate the fibers 14 together. As the oil 18-coated fibers 14 agglomerate into a matrix, the proppant 16 may be trapped and held within the fiber-binding liquid matrix forming clusters 20 as seen in FIG. 5. The clusters 20 prop the fracture open to form hydraulically conductive channels 22 between the clusters 20 for the flow of reservoir fluids toward the wellbore during a production phase.

In embodiments, the agglomerant aid may be introduced into the treatment fluid in a number of ways. In some embodiments the agglomerant aid may be a binding liquid, which may be immiscible with a continuous phase of the carrier fluid, e.g., a hydrophobic binding liquid in an aqueous carrying fluid, or a hydrophilic binding liquid in an oleophilic carrying fluid. In embodiments, the binding liquid may be a hydrophobic liquid generated from a viscoelastic surfactant (VES), such as for example, a VES formed from a fatty acid in anionic form at high pH. In some embodiments, the VES can associate into entangled wormlike micelles to give viscosity to the carrying fluid for the proppant/fiber injection step to carry the proppant and fiber into the fracture at high pH, and once placed in the fracture, the VES can be broken by reducing the pH to convert the carboxylate salt to carboxylic acid form of the fatty acid, in the form of an oil material released as the binding liquid for proppant/fiber agglomeration, which may also be facilitated by simultaneously reducing the viscosity to facilitate movement of the proppant and fiber and movement and coalescence of the binding liquid droplets.

In some embodiments the pH reduction can be generated in situ by degrading an acid precursor such as a polyester such as polylactic acid, polyglycolic acid or a copolymer thereof, or released from an encapsulated acid that can break or melt downhole, e.g., wax coated citric acid using a commercially available wax having a melting point of about 55° C. compatible with downhole release. In some embodiments, the liquid wax may also function as a binding liquid, e.g., the wax may be miscible with or promote coalescence of the hydrophobic binding liquid released from the VES or other agglomerant aid.

In some embodiments, the pH reduction may be based on ester chemistry, in which the kinetics are dependent on the concentration and chemistry of the ester, as well as the temperature of the wellbore and/or the formation. The ester based pH reducers in this example undergo rapid hydrolysis to promote proppant/fiber agglomeration and/or settling in the fracture in advance of proppant closure. The ester based decrosslinkers in some embodiments may be applicable in relatively high temperature formations, such as, for example, between 51.6° C. (125° F.) and 90° C. (194° F.). In some embodiments, the esters are alpha- and/or beta-branched carboxylic acids, branched alkyl carboxylates, i.e., an ester based on a branched alcohol such as diisopropyl malonate or di-tert-butyl malonate, and dibasic esters, that may exhibit relatively slower kinetics in their hydrolysis in alkaline solutions to facilitate viscosity retention during proppant placement.

In some embodiments, the hydrophobic binding liquid may be generated by destabilizing an oil-in-water emulsion, which in embodiments may not form a VES. While in an emulsion, oil droplets in some embodiments are stabilized by surfactants and not accessible, i.e., delayed or inactivated during the proppant placement procedure. Using reactive or degradable surfactants in some embodiments, the oil can be released from the emulsion, e.g., pH-sensitive surfactants can be used. To reduce pH the esters and other components just described for the embodiments of VES may be employed; to increase the pH, encapsulated bases or base precursors may be used. In embodiments, the binding liquid may be the binding liquid or other material present in or introduced into the treatment fluid as described in U.S. Pat. No. 8,141,637, which is hereby incorporated in its entirety herein by reference.

In some embodiments, the movement of proppant into clusters may optionally be facilitated, e.g., by activation of a trigger to destabilize the fracturing fluid, such as, for example, a breaker or decrosslinking additive to at least partially reduce the viscosity of the fracturing fluid, e.g., from a viscosity corresponding to a crosslinked polymer to that of a linear polymer. Agglomerants such as fibers may optionally also settle in the fracture, e.g., at a slower rate than the proppant, which may result in some embodiments from the agglomerants having a specific gravity that is equal to or closer to that of the carrier fluid than that of the proppant. As one non-limiting example, the proppant may be sand with a specific gravity of about 2.65, the agglomerants may be a localized fiber-laden region comprising fiber with a specific gravity of 1.1-1.5, e.g., polylactic acid fibers having a specific gravity of 1.25, and the carrier fluid may be aqueous with a specific gravity of 1-1.1. In some embodiments settling of the proppant may also be mediated by buoyancy imparted by the binding liquid, which may have a specific gravity lower than that of the proppant, agglomerant or carrier liquid. In this example, the agglomerant/binding liquid adducts may have a lower settling rate relative to the proppant. In other embodiments, the agglomerants may interact with either or both of the fracture faces, e.g. by friction or adhesion, which may similarly be mediated by the presence of the binding liquid in some embodiments, e.g., where the binding liquid has an affinity for the formation surface, and may have a density similar or dissimilar to that of the proppant, e.g., glass fibers may have a specific gravity greater than 2.

As a result of coalescence induced by the binding liquid and/or differential settling rates in the carrying fluid according to some embodiments, the proppant may form clusters adjacent respective agglomerants, facilitated by the presence of the binding liquid, and settling is retarded. Finally, in some embodiments, the agglomerants may be anchorants which are activated to form immobilized anchoring structures, which may be mediated by the binding liquid, to hold the clusters fast against the opposing surface(s) of the fracture.

In some embodiments, the method decreases the viscosity of a fracturing fluid comprising a crosslinked polymeric viscosifier for proppant placement, in one stage to that of a linear gel, to promote proppant/agglomerant/binding liquid agglomeration for in-situ channelization, but without completely breaking the viscosity to facilitate anchoring prior to fracture closure, i.e., the formation or activation of anchors to inhibit complete settling of the proppant system to the floor of the fracture.

The in-situ channelization concept is based on the creation of clusters, which in some embodiments may be anchored in the fracture, to promote wide conductive channels. Anchors are materials designed to stay in place in the fracture, while clusters are the agglomeration of sand and any fiber, binding liquid or other materials that settle on top of the anchors after placement but before fracture closure. To initiate settling of the sand to settle, a decrease in the fluid viscosity is implemented in some embodiments. In some embodiments, the acid or acid precursor may function as a de-crosslinker which is mixed homogenously in the treatment fluid at the surface, and pumped down the wellbore and into the fracture. After placement, the de-crosslinker, which in some embodiments may be based on ester chemistry as discussed above in connection with the VES and oil-in-water emulsion, is allowed to react with the crosslinked polymer to reduce its viscosity. After fracture closure, a breaker such as an oxidative breaker may break and/or, in the case of a partially broken or decrosslinked viscosifier, continue to more fully break the viscosifier to facilitate cleanup and reservoir production.

In-situ channelization promotes high conductivity through the formation of wide channels, relying on the settlement of the proppant and fibers on the anchors to form clusters, leaving high conductive channels free of proppant surrounding the clusters. The rate of settlement of the proppant is related to the creation of clusters, where a high settling rate can lead to no anchors or clusters, whereas a slow settling rate can lead to no channels due to premature fracture closure. The settlement of the sand depends on the viscosity of the fluid, and also, according to embodiments herein, on the rate at which this viscosity decreases at the reservoir temperature.

In one representative example according to some embodiments, a gelling agent is guar based, crosslinked with borate or with a delayed crosslinker (when having an oil-in-water emulsion which may employ alkaline emulsifiers for stability, which may be destabilized by reducing the pH). In some embodiments, the crosslinkers are used to create highly viscous gels comprising a stable oil-in-water emulsion at a pH between 8 and 12. In some embodiments, esters are used as dual functionality demulsifiers and decrosslinkers, since at high reservoir temperatures some esters can undergo hydrolysis and form carboxylic acids, lowering the pH of the fluid and thus destabilizing the emulsion to release the oil phase while simultaneously deactivating the borate or other crosslinker and thereby decrosslinking the fluid to improve mobility of the oil, agglomerants and proppants.

A system used to implement the fracture treatment may include a pump system comprising one or more pumps to supply the treatment fluid to the wellbore and fracture. In embodiments, the wellbore may include a substantially horizontal portion, which may be cased or completed open hole, wherein the fracture is transversely or longitudinally oriented and thus generally vertical or sloped with respect to horizontal. A mixing station in some embodiments may be provided at the surface to supply a mixture of carrier fluid, proppant, agglomerant, agglomerant aid, agglomerant aid activator, viscosifier, decrosslinking agent, etc., which may for example be an optionally stabilized concentrated blend slurry (CBS) to allow reliable control of the proppant concentration, any fiber, agglomerant aid, etc., which may for example be a concentrated masterbatch to allow reliable control of the concentration of the fiber, proppant, agglomerant aid, etc., and any other additives which may be supplied in any order, such as, for example, other viscosifiers, loss control agents, friction reducers, clay stabilizers, biocides, crosslinkers, breakers, breaker aids, corrosion inhibitors, and/or proppant flowback control additives, or the like.

In some embodiments, concentrations of one or more additives, including the proppants, fibers, agglomerant aid, or the like, to the fracturing fluid may be alternated. For example agglomerants/agglomerant aids may be alternatingly added, or a higher agglomerant/agglomerant aid concentration may be added, to form slugs of treatment fluid in which agglomeration and/or settling is promoted or inhibited, which may accumulate clusters during channelization, but which may be completely degraded after fracture closure to widen channels or form additional channels. Two or more additives (including agglomerants and/or agglomerant aids) may also be alternated independently.

The well may if desired also be provided with a shut in valve to maintain pressure in the wellbore and fracture, a flow-back/production line to flow back or produce fluids either during or post-treatment, as well as any conventional wellhead equipment.

If desired in some embodiments, the pumping schedule may be employed according to the alternating-proppant loading technology disclosed in U.S. Patent Application Publication No. US 2008/0135242, which is hereby incorporated herein by reference.

In some embodiments, a treatment slurry stage has a continuous concentration of a first solid particulate, e.g., proppant, and a discontinuous concentration of an additive that facilitates either clustering of the first solid particulate in the fracture, or anchoring of the clusters in the fracture, or a combination thereof, to form clusters of the first solid particulate to prop open the fracture upon closure. As used herein, “anchorant” refers to a material, a precursor material, or a mechanism, that inhibits movement such as settling, or preferably stops movement, of particulates or clusters of particulates in a fracture, whereas an “anchor” refers to an anchorant that is active or activated to inhibit or stop the movement. In some embodiments, the agglomerant may be an anchorant that may comprise a material, such as fibers, flocs, flakes, discs, rods, stars, etc., for example, which may be heterogeneously distributed in the fracture and have a different movement rate, and/or cause some of the first solid particulate to have a different movement rate, which may be faster or preferably slower with respect to the settling of the first solid particulate and/or clusters. As used herein, the term “flocs” includes both flocculated colloids and colloids capable of forming flocs in the treatment slurry stage.

In some embodiments, the agglomerant/anchorant may adhere to one or both opposing surfaces of the fracture to stop movement of a proppant particle cluster and/or to provide immobilized structures upon which proppant or proppant cluster(s) may accumulate. In some embodiments, the agglomerants/anchors may adhere to each other to facilitate consolidation, stability and/or strength of the formed clusters, which adherence may be mediated by the presence or generation of the binding liquid. Adherence of the agglomerants to each other and/or to the fracture surface may be promoted by the binding liquid in some embodiments.

In some embodiments, the anchorant may comprise a continuous concentration of a first anchorant component and a discontinuous concentration of a second anchorant component, e.g., where the first and second anchorant components may react or combine to form the anchor as in a fiber/binding liquid system, a two-reactant system, a catalyst/reactant system, a pH-sensitive reactant/pH modifier system (which may be or include the decrosslinker), or the like.

In some embodiments, the anchorant may form boundaries for particulate movement, e.g., lower boundaries for particulate settling.

In some embodiments, the conductive channels extend in fluid communication from adjacent a face of in the formation away from the wellbore to or to near the wellbore, e.g., to facilitate the passage of fluid between the wellbore and the formation, such as in the production of reservoir fluids and/or the injection of fluids into the formation matrix. As used herein, “near the wellbore” refers to conductive channels coextensive along a majority of a length of the fracture terminating at a permeable matrix between the conductive channels and the wellbore, e.g., where the region of the fracture adjacent the wellbore is filled with a permeable solids pack as in a high conductive proppant tail-in stage, gravel packing or the like.

In some embodiments, a method for treating a subterranean formation penetrated by a wellbore comprises: injecting into a fracture in the formation at a continuous rate a treatment fluid stage with a continuous first solid particulate concentration; while maintaining the continuous rate and first solid particle concentration during injection of the treatment fluid stage, successively alternating concentration modes of an anchorant, such as fiber, in the treatment fluid stage between a plurality of relatively anchorant-rich modes and a plurality of anchorant-lean modes within the injected treatment fluid stage.

In some embodiments, the injection of the treatment fluid stage forms a homogenous region within the fracture of continuously uniform distribution of the first solid particulate. In some embodiments, the alternation of the concentration of the agglomerant and/or agglomerant aid forms heterogeneous areas within the fracture comprising agglomerant/agglomerant aid-rich areas and agglomerant/agglomerant aid-lean areas.

In some embodiments, the agglomerant may comprise a degradable material. In some embodiments, the agglomerant is selected from the group consisting of polylactic acid (PLA), polyglycolic acid (PGA), polyethylene terephthalate (PET), polyester, polyamide, polycaprolactam and polylactone, poly(butylene succinate, polydioxanone, glass, ceramics, carbon (including carbon-based compounds), elements in metallic form, metal alloys, wool, basalt, acrylic, polyethylene, polypropylene, novoloid resin, polyphenylene sulfide, polyvinyl chloride, polyvinylidene chloride, polyurethane, polyvinyl alcohol, polybenzimidazole, polyhydroquinone-diimidazopyridine, poly(p-phenylene-2,6-benzobisoxazole), rayon, cotton, or other natural fibers, rubber, sticky fiber, or a combination thereof. In some embodiments the agglomerant may comprise acrylic fiber. In some embodiments the agglomerant may comprise mica.

In some embodiments, the agglomerant is present in the agglomerant-laden stages of the treatment slurry in an amount of less than 5 vol %. All individual values and subranges from less than 5 vol % are included and disclosed herein. For example, the amount of agglomerant may be from 0.05 vol % to less than 5 vol %, or less than 1 vol %, or less than 0.5 vol %. The agglomerant may be present in an amount from 0.5 vol % to 1.5 vol %, or in an amount from 0.01 vol % to 0.5 vol %, or in an amount from 0.05 vol % to 0.5 vol %.

In further embodiments, the agglomerant may comprise a fiber with a length from 1 to 50 mm, or more specifically from 1 to 10 mm, and a diameter of from 1 to 50 microns, or, more specifically from 1 to 20 microns. All values and subranges from 1 to 50 mm are included and disclosed herein. For example, the fiber agglomerant length may be from a lower limit of 1, 3, 5, 7, 9, 19, 29 or 49 mm to any higher upper limit of 2, 4, 6, 8, 10, 20, 30 or 50 mm. The fiber agglomerant length may range from 1 to 50 mm, or from 1 to 10 mm, or from 1 to 7 mm, or from 3 to 10 mm, or from 2 to 8 mm. All values from 1 to 50 microns are included and disclosed herein. For example, the fiber agglomerant diameter may be from a lower limit of 1, 4, 8, 12, 16, 20, 30, 40, or 49 microns to an upper limit of 2, 6, 10, 14, 17, 22, 32, 42 or 50 microns. The fiber agglomerant diameter may range from 1 to 50 microns, or from 10 to 50 microns, or from 1 to 15 microns, or from 2 to 17 microns.

In further embodiments, the agglomerant may be fiber selected from the group consisting of polylactic acid (PLA), polyester, polycaprolactam, polyamide, polyglycolic acid, polyterephthalate, cellulose, wool, basalt, glass, rubber, or a combination thereof.

In further embodiments, the agglomerant may comprise a fiber with a length from 0.001 to 1 mm and a diameter of from 50 nanometers (nm) to 10 microns. All individual values from 0.001 to 1 mm are disclosed and included herein. For example, the agglomerant fiber length may be from a lower limit of 0.001, 0.01, 0.1 or 0.9 mm to any higher upper limit of 0.009, 0.07, 0.5 or 1 mm. All individual values from 50 nanometers to 10 microns are included and disclosed herein. For example, the fiber agglomerant diameter may range from a lower limit of 50, 60, 70, 80, 90, 100, or 500 nanometers to an upper limit of 500 nanometers, 1 micron, or 10 microns.

In some embodiments, the agglomerant may comprise an expandable material, such as, for example, swellable elastomers, temperature expandable particles, Examples of oil swellable elastomers include butadiene based polymers and copolymers such as styrene butadiene rubber (SBR), styrene butadiene block copolymers, styrene isoprene copolymer, acrylate elastomers, neoprene elastomers, nitrile elastomers, vinyl acetate copolymers and blends of EV A, and polyurethane elastomers. Examples of water and brine swellable elastomers include maleic acid grafted styrene butadiene elastomers and acrylic acid grafted elastomers. Examples of temperature expandable particles include metals and gas filled particles that expand more when the particles are heated relative to silica sand. In some embodiments, the expandable metals can include a metal oxide of Ca, Mn, Ni, Fe, etc. that reacts with the water to generate a metal hydroxide which has a lower density than the metal oxide, i.e., the metal hydroxide occupies more volume than the metal oxide thereby increasing the volume occupied by the particle. Further examples of swellable inorganic materials can be found in U.S. Application Publication Number US 20110098202, which is hereby incorporated by reference in its entirety. An example for gas filled material is EXPANCEL™ microspheres that are manufactured by and commercially available from Akzo Nobel of Chicago, Ill. These microspheres contain a polymer shell with gas entrapped inside. When these microspheres are heated the gas inside the shell expands and increases the size of the particle. The diameter of the particle can increase 4 times which could result in a volume increase by a factor of 64.

In some embodiments the agglomerants may be gel bodies such as balls or blobs made with a viscosifier, such as for example, a water soluble polymer such as polysaccharide like hydroxyethylcellulose (HEC) and/or guar, copolymers of polyacrylamide and their derivatives, and the like, e.g., at a concentration of 1.2 to 24 g/L (10 to 200 ppt where “ppt” is pounds per 1000 gallons of fluid), or a viscoelastic surfactant (VES). The polymer in some embodiments may be crosslinked with a crosslinker such as metal, e.g., calcium or borate. The gel bodies may further optionally comprise fibers and/or particulates dispersed in an internal phase. The gel bodies may be made from the same or different polymer and/or crosslinker as the continuous crosslinked polymer phase, but may have a different viscoelastic characteristic or morphology.

In some embodiments, a system to produce reservoir fluids comprises the wellbore and the fracture resulting from any of the fracturing methods disclosed herein.

The following discussion is based on specific examples according to some embodiments wherein the first particulate comprises proppant and the agglomerant or anchor, where present, comprises fiber. In some specific embodiments illustrated below, the wellbore is oriented horizontally and the fracture is generally vertical, however, the disclosure herein is not limited to this specific configuration.

As used herein, the terms “treatment fluid” or “wellbore treatment fluid” are inclusive of “fracturing fluid” or “treatment slurry” and should be understood broadly. These may be or include a liquid, a solid, a gas, and combinations thereof, as will be appreciated by those skilled in the art. A treatment fluid may take the form of a solution, an emulsion, an energized fluid (including foam), slurry, or any other form as will be appreciated by those skilled in the art.

As used herein, “slurry” refers to an optionally flowable mixture of particles dispersed in a fluid carrier. The terms “flowable” or “pumpable” or “mixable” are used interchangeably herein and refer to a fluid or slurry that has either a yield stress or low-shear (5.11 s⁻¹) viscosity less than 1000 Pa and a dynamic apparent viscosity of less than 10 Pa-s (10,000 cP) at a shear rate 170 s⁻¹, where yield stress, low-shear viscosity and dynamic apparent viscosity are measured at a temperature of 25° C. unless another temperature is specified explicitly or in context of use.

“Viscosity” as used herein unless otherwise indicated refers to the apparent dynamic viscosity of a fluid at a temperature of 25° C. and shear rate of 170 s⁻¹.

“Treatment fluid” or “fluid” (in context) refers to the entire treatment fluid, including any proppant, subproppant particles, liquid, gas etc. “Whole fluid,” “total fluid” and “base fluid” are used herein to refer to the fluid phase plus any subproppant particles dispersed therein, but exclusive of proppant particles. “Carrier,” “fluid phase” or “liquid phase” refer to the fluid or liquid that is present, which may comprise a continuous phase and optionally one or more discontinuous gas or liquid fluid phases dispersed in the continuous phase, including any solutes, thickeners or colloidal particles only, exclusive of other solid phase particles; reference to “water” in the slurry refers only to water and excludes any gas, liquid or solid particles, solutes, thickeners, colloidal particles, etc.; reference to “aqueous phase” refers to a carrier phase comprised predominantly of water, which may be a continuous or dispersed phase. As used herein the terms “liquid” or “liquid phase” encompasses both liquids per se and supercritical fluids, including any solutes dissolved therein.

The term “dispersion” means a mixture of one substance dispersed in another substance, and may include colloidal or non-colloidal systems. As used herein, “emulsion” generally means any system with one liquid phase dispersed in another immiscible liquid phase, and may apply to oil-in-water and water-in-oil emulsions. Invert emulsions refer to any water-in-oil emulsion in which oil is the continuous or external phase and water is the dispersed or internal phase.

The terms “energized fluid” and “foam” refer to a fluid which when subjected to a low pressure environment liberates or releases gas from solution or dispersion, for example, a liquid containing dissolved gases. Foams or energized fluids are stable mixtures of gases and liquids that form a two-phase system. Foam and energized fluids are generally described by their foam quality, i.e. the ratio of gas volume to the foam volume (fluid phase of the treatment fluid), i.e., the ratio of the gas volume to the sum of the gas plus liquid volumes). If the foam quality is between 52% and 95%, the energized fluid is usually called foam. Above 95%, foam is generally changed to mist. In the present patent application, the term “energized fluid” also encompasses foams and refers to any stable mixture of gas and liquid, regardless of the foam quality. Energized fluids comprise any of:
(a) Liquids that at bottom hole conditions of pressure and temperature are close to saturation with a species of gas. For example the liquid can be aqueous and the gas nitrogen or carbon dioxide. Associated with the liquid and gas species and temperature is a pressure called the bubble point, at which the liquid is fully saturated. At pressures below the bubble point, gas emerges from solution;
(b) Foams, consisting generally of a gas phase, an aqueous phase and a solid phase. At high pressures the foam quality is typically low (i.e., the non-saturated gas volume is low), but quality (and volume) rises as the pressure falls. Additionally, the aqueous phase may have originated as a solid material and once the gas phase is dissolved into the solid phase, the viscosity of solid material is decreased such that the solid material becomes a liquid; or
(c) Liquefied gases.

As used herein unless otherwise specified, as described in further detail herein, particle size and particle size distribution (PSD) mode refer to the median volume averaged size. The median size used herein may be any value understood in the art, including for example and without limitation a diameter of roughly spherical particulates. In an embodiment, the median size may be a characteristic dimension, which may be a dimension considered most descriptive of the particles for specifying a size distribution range.

As used herein, a “water soluble polymer” refers to a polymer which has a water solubility of at least 5 wt % (0.5 g polymer in 9.5 g water) at 25° C.

The measurement or determination of the viscosity of the liquid phase (as opposed to the treatment fluid or base fluid) may be based on a direct measurement of the solids-free liquid, or a calculation or correlation based on a measurement(s) of the characteristics or properties of the liquid containing the solids, or a measurement of the solids-containing liquid using a technique where the determination of viscosity is not affected by the presence of the solids. As used herein, solids-free for the purposes of determining the viscosity of the liquid phase means in the absence of non-colloidal particles larger than 1 micron such that the particles do not affect the viscosity determination, but in the presence of any submicron or colloidal particles that may be present to thicken and/or form a gel with the liquid, i.e., in the presence of ultrafine particles that can function as a thickening agent. In some embodiments, a “low viscosity liquid phase” means a viscosity less than about 300 mPa-s measured without any solids greater than 1 micron at 170 s⁻¹ and 25° C.

In some embodiments, the treatment fluid may include a continuous fluid phase, also referred to as an external phase, and a discontinuous phase(s), also referred to as an internal phase(s), which may be a fluid (liquid or gas) in the case of an emulsion, foam or energized fluid, or which may be a solid in the case of a slurry. The continuous fluid phase, also referred to herein as the carrier fluid or comprising the carrier fluid, may be any matter that is substantially continuous under a given condition. Examples of the continuous fluid phase include, but are not limited to, water, hydrocarbon, gas (e.g., nitrogen or methane), liquefied gas (e.g., propane, butane, or the like), etc., which may include solutes, e.g. the fluid phase may be a brine, and/or may include a brine or other solution(s). In some embodiments, the fluid phase(s) may optionally include a viscosifying and/or yield point agent and/or a portion of the total amount of viscosifying and/or yield point agent present. Some non-limiting examples of the fluid phase(s) include hydratable gels and mixtures of hydratable gels (e.g. gels containing polysaccharides such as guars and their derivatives, xanthan and diutan and their derivatives, hydratable cellulose derivatives such as hydroxyethylcellulose, carboxymethylcellulose and others, polyvinyl alcohol and its derivatives, other hydratable polymers, colloids, etc.), a cross-linked hydratable gel, a viscosified acid (e.g. gel-based), an emulsified acid (e.g. oil outer phase), an energized fluid (e.g., an N₂ or CO₂ based foam), a viscoelastic surfactant (VES) viscosified fluid, and an oil-based fluid including a gelled, foamed, or otherwise viscosified oil.

The discontinuous phase if present in the treatment fluid may be any particles (including fluid droplets) that are suspended or otherwise dispersed in the continuous phase in a disjointed manner. In this respect, the discontinuous phase can also be referred to, collectively, as “particle” or “particulate” which may be used interchangeably. As used herein, the term “particle” should be construed broadly. For example, in some embodiments, the particle(s) of the current application are solid such as proppant, sands, ceramics, crystals, salts, etc.; however, in some other embodiments, the particle(s) can be liquid, gas, foam, emulsified droplets, etc. Moreover, in some embodiments, the particle(s) of the current application are substantially stable and do not change shape or form over an extended period of time, temperature, or pressure; in some other embodiments, the particle(s) of the current application are degradable, expandable, swellable, dissolvable, deformable, meltable, sublimeable, or otherwise capable of being changed in shape, state, or structure.

In an embodiment, the particle(s) is substantially round and spherical. In an embodiment, the particle(s) is not substantially spherical and/or round, e.g., it can have varying degrees of sphericity and roundness, according to the API RP-60 sphericity and roundness index. For example, the particle(s) used as anchorants or otherwise may have an aspect ratio of more than 2, 3, 4, 5 or 6. Examples of such non-spherical particles include, but are not limited to, fibers, flocs, flakes, discs, rods, stars, etc. All such variations should be considered within the scope of the current application.

Introducing high-aspect ratio particles into the treatment fluid, e.g., particles having an aspect ratio of at least 6, represents additional or alternative embodiments for stabilizing the treatment fluid and inhibiting settling during proppant placement, which can be removed, for example by dissolution or degradation into soluble degradation products. Examples of such non-spherical particles include, but are not limited to, fibers, flocs, flakes, discs, rods, stars, etc., as described in, for example, U.S. Pat. No. 7,275,596, US20080196896, which are hereby incorporated herein by reference. In an embodiment, introducing ciliated or coated proppant into the treatment fluid may also stabilize or help stabilize the treatment fluid or regions thereof. Proppant or other particles coated with a hydrophilic polymer can make the particles behave like larger particles and/or more tacky particles in an aqueous medium. The hydrophilic coating on a molecular scale may resemble ciliates, i.e., proppant particles to which hairlike projections have been attached to or formed on the surfaces thereof. Herein, hydrophilically coated proppant particles are referred to as “ciliated or coated proppant.” Hydrophilically coated proppants and methods of producing them are described, for example, in WO 2011-050046, U.S. Pat. No. 5,905,468, U.S. Pat. No. 8,227,026 and U.S. Pat. No. 8,234,072, which are hereby incorporated herein by reference.

In an embodiment, the particles may be multimodal. As used herein multimodal refers to a plurality of particle sizes or modes which each has a distinct size or particle size distribution, e.g., proppant and fines. As used herein, the terms distinct particle sizes, distinct particle size distribution, or multi-modes or multimodal, mean that each of the plurality of particles has a unique volume-averaged particle size distribution (PSD) mode. That is, statistically, the particle size distributions of different particles appear as distinct peaks (or “modes”) in a continuous probability distribution function. For example, a mixture of two particles having normal distribution of particle sizes with similar variability is considered a bimodal particle mixture if their respective means differ by more than the sum of their respective standard deviations, and/or if their respective means differ by a statistically significant amount. In an embodiment, the particles contain a bimodal mixture of two particles; in an embodiment, the particles contain a trimodal mixture of three particles; in an embodiment, the particles contain a tetramodal mixture of four particles; in an embodiment, the particles contain a pentamodal mixture of five particles, and so on. Representative references disclosing multimodal particle mixtures include U.S. Pat. No. 5,518,996, U.S. Pat. No. 7,784,541, U.S. Pat. No. 7,789,146, U.S. Pat. No. 8,008,234, U.S. Pat. No. 8,119,574, U.S. Pat. No. 8,210,249, US 2010/0300688, US 2012/0000641, US 2012/0138296, US 2012/0132421, US 2012/0111563, WO 2012/054456, US 2012/0305245, US 2012/0305254, US 2012/0132421, WO2013/085412 and US 2013/0233542, each of which are hereby incorporated herein by reference.

“Solids” and “solids volume” refer to all solids present in the slurry, including proppant and subproppant particles, including particulate thickeners such as colloids and submicron particles. “Solids-free” and similar terms generally exclude proppant and subproppant particles, except particulate thickeners such as colloids for the purposes of determining the viscosity of a “solids-free” fluid.

“Proppant” refers to particulates that are used in well work-overs and treatments, such as hydraulic fracturing operations, to hold fractures open following the treatment. In some embodiments, the proppant may be of a particle size mode or modes in the slurry having a weight average mean particle size greater than or equal to about 100 microns, e.g., 140 mesh particles correspond to a size of 105 microns. In further embodiments, the proppant may comprise particles or aggregates made from particles with size from 0.001 to 1 mm. All individual values from 0.001 to 1 mm are disclosed and included herein. For example, the solid particulate size may be from a lower limit of 0.001, 0.01, 0.1 or 0.9 mm to an upper limit of 0.009, 0.07, 0.5 or 1 mm. Here particle size is defined is the largest dimension of the grain of said particle.

“Gravel” refers to particles used in gravel packing, and the term is synonymous with proppant as used herein. “Sub-proppant” or “subproppant” refers to particles or particle size or mode (including colloidal and submicron particles) having a smaller size than the proppant mode(s); references to “proppant” exclude subproppant particles and vice versa. In an embodiment, the sub-proppant mode or modes each have a weight average mean particle size less than or equal to about one-half of the weight average mean particle size of a smallest one of the proppant modes, e.g., a suspensive/stabilizing mode.

The proppant, when present, can be naturally occurring materials, such as sand grains. The proppant, when present, can also be man-made or specially engineered, such as coated (including resin-coated) sand, modulus of various nuts, high-strength ceramic materials like sintered bauxite, etc. In some embodiments, the proppant of the current application, when present, has a density greater than 2.45 g/mL, e.g., 2.5-2.8 g/mL, such as sand, ceramic, sintered bauxite or resin coated proppant. In some embodiments, the proppant of the current application, when present, has a density greater than or equal to 2.8 g/mL, and/or the treatment fluid may comprise an apparent specific gravity less than 1.5, less than 1.4, less than 1.3, less than 1.2, less than 1.1, or less than 1.05, less than 1, or less than 0.95, for example. In some embodiments a relatively large density difference between the proppant and carrier fluid may enhance proppant settling during the clustering phase, for example.

In some embodiments, the proppant of the current application, when present, has a density less than or equal to 2.45 g/mL, such as light/ultralight proppant from various manufacturers, e.g., hollow proppant. In some embodiments, the treatment fluid comprises an apparent specific gravity greater than 1.3, greater than 1.4, greater than 1.5, greater than 1.6, greater than 1.7, greater than 1.8, greater than 1.9, greater than 2, greater than 2.1, greater than 2.2, greater than 2.3, greater than 2.4, greater than 2.5, greater than 2.6, greater than 2.7, greater than 2.8, greater than 2.9, or greater than 3. In some embodiments where the proppant may be buoyant, i.e., having a specific gravity less than that of the carrier fluid, the term “settling” shall also be inclusive of upward settling or floating.

“Stable” or “stabilized” or similar terms refer to a concentrated blend slurry (CBS) wherein gravitational settling of the particles is inhibited such that no or minimal free liquid is formed, and/or there is no or minimal rheological variation among strata at different depths in the CBS, and/or the slurry may generally be regarded as stable over the duration of expected CBS storage and use conditions, e.g., a CBS that passes a stability test or an equivalent thereof. In an embodiment, stability can be evaluated following different settling conditions, such as for example static under gravity alone, or dynamic under a vibratory influence, or dynamic-static conditions employing at least one dynamic settling condition followed and/or preceded by at least one static settling condition.

The static settling test conditions can include gravity settling for a specified period, e.g., 24 hours, 48 hours, 72 hours, or the like, which are generally referred to with the respective shorthand notation “24 h-static”, “48 h-static” or “72 h static”. Dynamic settling test conditions generally indicate the vibratory frequency and duration, e.g., 4 h@15 Hz (4 hours at 15 Hz), 8 h@5 Hz (8 hours at 5 Hz), or the like. Dynamic settling test conditions are at a vibratory amplitude of 1 mm vertical displacement unless otherwise indicated. Dynamic-static settling test conditions will indicate the settling history preceding analysis including the total duration of vibration and the final period of static conditions, e.g., 4 h@15 Hz/20 h-static refers to 4 hours vibration followed by 20 hours static, or 8 h@15 Hz/10 d-static refers to 8 hours total vibration, e.g., 4 hours vibration followed by 20 hours static followed by 4 hours vibration, followed by 10 days of static conditions. In the absence of a contrary indication, the designation “8 h@15 Hz/10 d-static” refers to the test conditions of 4 hours vibration, followed by 20 hours static followed by 4 hours vibration, followed by 10 days of static conditions. In the absence of specified settling conditions, the settling condition is 72 hours static. The stability settling and test conditions are at 25° C. unless otherwise specified.

As used herein, a concentrated blend slurry (CBS) may meet at least one of the following conditions:
(1) the slurry has a low-shear viscosity equal to or greater than 1 Pa-s (5.11 s⁻¹, 25° C.);
(2) the slurry has a Herschel-Bulkley (including Bingham plastic) yield stress (as determined in the manner described herein) equal to or greater than 1 Pa; or
(3) the largest particle mode in the slurry has a static settling rate less than 0.01 mm/hr; or
(4) the depth of any free fluid at the end of a 72-hour static settling test condition or an 8 h@15 Hz/10 d-static dynamic settling test condition (4 hours vibration followed by 20 hours static followed by 4 hours vibration followed finally by 10 days of static conditions) is no more than 2% of total depth; or
(5) the apparent dynamic viscosity (25° C., 170 s⁻¹) across column strata after the 72-hour static settling test condition or the 8 h@15 Hz/10 d-static dynamic settling test condition is no more than +/−20% of the initial dynamic viscosity; or
(6) the slurry solids volume fraction (SVF) across the column strata below any free water layer after the 72-hour static settling test condition or the 8 h@15 Hz/10 d-static dynamic settling test condition is no more than 5% greater than the initial SVF; or
(7) the density across the column strata below any free water layer after the 72-hour static settling test condition or the 8 h@15 Hz/10 d-static dynamic settling test condition is no more than 1% of the initial density.

In some embodiments, the concentrated blend slurry comprises at least one of the following stability indicia: (1) an SVF of at least 0.4 up to SVF=PVF; (2) a low-shear viscosity of at least 1 Pa-s (5.11 s⁻¹, 25° C.); (3) a yield stress (as determined herein) of at least 1 Pa; (4) an apparent viscosity of at least 50 mPa-s (170 s⁻¹, 25° C.); (5) a multimodal solids phase; (6) a solids phase having a PVF greater than 0.7; (7) a viscosifier selected from viscoelastic surfactants, in an amount ranging from 0.01 up to 7.2 g/L (60 ppt), and hydratable gelling agents in an amount ranging from 0.01 up to 4.8 g/L (40 ppt) based on the volume of fluid phase; (8) colloidal particles; (9) a particle-fluid density delta less than 1.6 g/mL, (e.g., particles having a specific gravity less than 2.65 g/mL, carrier fluid having a density greater than 1.05 g/mL or a combination thereof); (10) particles having an aspect ratio of at least 6; (11) ciliated or coated proppant; and (12) combinations thereof.

In an embodiment, the concentrated blend slurry is formed (stabilized) by at least one of the following slurry stabilization operations: (1) introducing sufficient particles into the slurry or treatment fluid to increase the SVF of the treatment fluid to at least 0.4; (2) increasing a low-shear viscosity of the slurry or treatment fluid to at least 1 Pa-s (5.11 s⁻¹, 25° C.); (3) increasing a yield stress of the slurry or treatment fluid to at least 1 Pa; (4) increasing apparent viscosity of the slurry or treatment fluid to at least 50 mPa-s (170 s⁻¹, 25° C.); (5) introducing a multimodal solids phase into the slurry or treatment fluid; (6) introducing a solids phase having a PVF greater than 0.7 into the slurry or treatment fluid; (7) introducing into the slurry or treatment fluid a viscosifier selected from viscoelastic surfactants, e.g., in an amount ranging from 0.01 up to 7.2 g/L (60 ppt), and hydratable gelling agents, e.g., in an amount ranging from 0.01 up to 4.8 g/L (40 ppt) based on the volume of fluid phase; (8) introducing colloidal particles into the slurry or treatment fluid; (9) reducing a particle-fluid density delta to less than 1.6 g/mL (e.g., introducing particles having a specific gravity less than 2.65 g/mL, carrier fluid having a density greater than 1.05 g/mL or a combination thereof); (10) introducing particles into the slurry or treatment fluid having an aspect ratio of at least 6; (11) introducing ciliated or coated proppant into slurry or treatment fluid; and (12) combinations thereof. The slurry stabilization operations may be separate or concurrent, e.g., introducing a single viscosifier may also increase low-shear viscosity, yield stress, apparent viscosity, etc., or alternatively or additionally with respect to a viscosifier, separate agents may be added to increase low-shear viscosity, yield stress and/or apparent viscosity.

Increasing carrier fluid viscosity in a Newtonian fluid also proportionally increases the resistance of the carrier fluid motion. In some embodiments, the carrier fluid has a lower limit of apparent dynamic viscosity, determined at 170 s⁻¹ and 25° C., of at least about 10 mPa-s, or at least about 25 mPa-s, or at least about 50 mPa-s, or at least about 75 mPa-s, or at least about 100 mPa-s, or at least about 150 mPa-s, or at least about 300 mPa-s, or at least about 500 mPa-s. A disadvantage of increasing the viscosity is that as the viscosity increases, the friction pressure for pumping the slurry generally increases as well. In some embodiments, the fluid carrier has an upper limit of apparent dynamic viscosity, determined at 170 s⁻¹ and 25° C., of less than about 1000 mPa-s, or less than about 500 mPa-s, or less than about 300 mPa-s, or less than about 150 mPa-s, or less than about 100 mPa-s, or less than about 50 mPa-s. In an embodiment, the fluid phase viscosity ranges from any lower limit to any higher upper limit.

In some embodiments, an agent may both viscosify and impart yield stress characteristics, and in further embodiments may also function as a friction reducer to reduce friction pressure losses in pumping the treatment fluid. In an embodiment, the liquid phase is essentially free of viscosifier or comprises a viscosifier in an amount ranging from 0.01 up to 12 g/L (0.08-100 ppt) of the fluid phase. The viscosifier can be a viscoelastic surfactant (VES) or a hydratable gelling agent such as a polysaccharide, which may be crosslinked. When using viscosifiers and/or yield stress fluids, proppant settling in some embodiments may be triggered by breaking the fluid using a breaker(s). In some embodiments, the slurry is stabilized for storage and/or pumping or other use at the surface conditions and proppant transport and placement, and settlement triggering is achieved downhole at a later time prior to fracture closure, which may be at a higher temperature, e.g., for some formations, the temperature difference between surface and downhole can be significant and useful for triggering degradation of the viscosifier, any stabilizing particles (e.g., subproppant particles) if present, a yield stress agent or characteristic, and/or a activation of a breaker. Thus in some embodiments, breakers that are either temperature sensitive or time sensitive, either through delayed action breakers or delay in mixing the breaker into the slurry to initiate destabilization of the slurry and/or proppant settling, can be useful.

In embodiments, the fluid may include leakoff control agents, such as, for example, latex dispersions, water soluble polymers, submicron particulates, particulates with an aspect ratio higher than 1, or higher than 6, combinations thereof and the like, such as, for example, crosslinked polyvinyl alcohol microgel. The fluid loss agent can be, for example, a latex dispersion of polyvinylidene chloride, polyvinyl acetate, polystyrene-co-butadiene; a water soluble polymer such as hydroxyethylcellulose (HEC), guar, copolymers of polyacrylamide and their derivatives; particulate fluid loss control agents in the size range of 30 nm to 1 micron, such as γ-alumina, colloidal silica, CaCO3, SiO2, bentonite etc.; particulates with different shapes such as glass fibers, flocs, flakes, films; and any combination thereof or the like. Fluid loss agents can if desired also include or be used in combination with acrylamido-methyl-propane sulfonate polymer (AMPS). In an embodiment, the leak-off control agent comprises a reactive solid, e.g., a hydrolyzable material such as PGA, PLA or the like; or it can include a soluble or solubilizable material such as a wax, an oil-soluble resin, or another material soluble in hydrocarbons, or calcium carbonate or another material soluble at low pH; and so on. In an embodiment, the leak-off control agent comprises a reactive solid selected from ground quartz, oil soluble resin, degradable rock salt, clay, zeolite or the like. In other embodiments, the leak-off control agent comprises one or more of magnesium hydroxide, magnesium carbonate, magnesium calcium carbonate, calcium carbonate, aluminum hydroxide, calcium oxalate, calcium phosphate, aluminum metaphosphate, sodium zinc potassium polyphosphate glass, and sodium calcium magnesium polyphosphate glass, or the like. The treatment fluid may also contain colloidal particles, such as, for example, colloidal silica, which may function as a loss control agent, gellant and/or thickener.

In embodiments, the proppant-containing treatment fluid may comprise from 0.06 or 0.12 g of proppant per mL of treatment fluid (corresponding to 0.5 or 1 ppa) up to 1.2 or 1.8 g/mL (corresponding to 10 or 15 ppa). In some embodiments, the proppant-laden treatment fluid may have a relatively low proppant loading in earlier-injected fracturing fluid and a relatively higher proppant loading in later-injected fracturing fluid, which may correspond to a relatively narrower fracture width adjacent a tip of the fracture and a relatively wider fracture width adjacent the wellbore. For example, the proppant loading may initially begin at 0.48 g/mL (4 ppa) and be ramped up to 0.6 g/mL (6 ppa) at the end.

In embodiments, the compositions may be used for diversion operation. Hydraulic and acid fracturing of horizontal wells as well as multi-layered formations frequently requires using diverting techniques in order to enable fracturing redirection between different zones. Diversion treatment with particulates is typically based on bridging of particles of the diverting material behind casing and forming a plug by accumulating the rest of the particles at the formed bridge. One of the issue with these type of treatment, when used as a pill for example, may be to keep the particles and the high aspect ratio agglomerant as a continuous slurry in the train of fluid. The presently described agglomerant aid may facilitate such operations.

In these configurations, the carrying fluid comprising, a low aspect ratio solid particulate, a high aspect ratio agglomerant, an agglomerant aid may be pumped as a pill in the train of fluid at a pressure typically below the fracturing pressure. Compositions and operations as described in US20120285692, incorporated herein by reference in its entirety, may be used when supplemented with an agglomerant aid. A mixture of degradable particles may be used or a mixture of degradable particles and proppants. This will enable degradation of the plug after operations.

### EXAMPLES

Examples 1 and 2: In these examples, a viscoelastic surfactant (VES) was prepared with 18 g/L of oleic acid, 2 g/L of acetic acid, 6 g/L of NaOH, and 50 g/L of KCl. Polylactic acid (PLA) fibers (length 6 mm, diameter 12 μm) were added to the VES at room temperature at a concentration of 12 g/L and mixed in a blender until a homogeneous slurry was formed, about 5 minutes at 3000 rpm. Solids (proppant/sand) were then added into the slurry and mixed with an overhead mixer for 2 minutes at 1000 rpm. The slurry was placed in a flat slot consisting of two panes of PLEXIGLASS™ organic glass 10 mm apart, stuck together via small panes of PLEXIGLASS™ organic glass 6 mm apart. The inner slot size was 220×220×6 mm, enclosing a volume of about 330 mL. The slot was placed in oven horizontally at 82° C. (180° F.) for 3 hours to initiate PLA degradation into lactic acid and lower the pH.

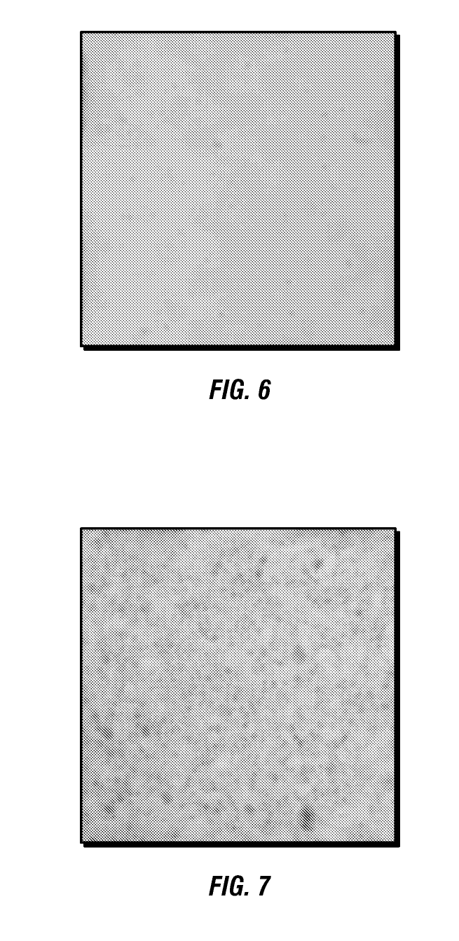

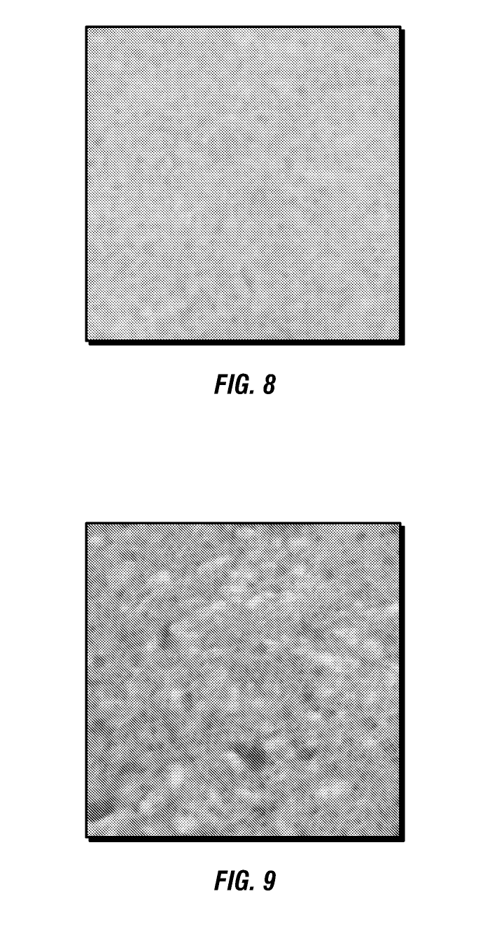

Formulation 1 was prepared with 240 g/L 100 mesh sand. The initial appearance of the mixture in the slot is seen in the photograph of FIG. 6. After heating for three hours, small pillars were observed as seen in FIG. 7. Formulation 2 was prepared with 120 g/L 30/50 mesh proppant. The before and after photos are seen in FIGS. 8 and 9. The relatively larger proppant, even at a lower loading, resulted in larger and denser pillars.

While the embodiments have been illustrated and described in detail in the drawings and foregoing description, the same is to be considered as illustrative and not restrictive in character, it being understood that only some embodiments have been shown and described and that all changes and modifications that come within the spirit of the embodiments are desired to be protected. It should be understood that while the use of words such as ideally, desirably, preferable, preferably, preferred, more preferred or exemplary utilized in the description above indicate that the feature so described may be more desirable or characteristic, nonetheless may not be necessary and embodiments lacking the same may be contemplated as within the scope of the disclosure, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A method to treat a subterranean formation penetrated by a wellbore, comprising:
providing a treatment slurry stage comprising a carrying fluid, a low aspect ratio solid particulate, a high aspect ratio agglomerant, and a delayed agglomerant aid;
injecting the treatment slurry stage above a fracturing pressure into the formation to distribute a mixture of the solid particulate, the agglomerant and the delayed agglomerant aid in a fracture;
activating the agglomerant aid to generate a binding liquid which is immiscible with the continuous phase of the carrier fluid, thus facilitating agglomeration of the solid particulate with the agglomerant;
prior to closure of the fracture, allowing the solid particulate to agglomerate in the fracture for a period of time to form clusters of the solid particulate in the mixture, and to form regions between the clusters that are substantially free of the solid particulate, wherein the formation of the clusters results at least in part from coalescence of the binding liquid; and
reducing pressure in the fracture to close the fracture onto the clusters and form interconnected, hydraulically conductive channels between the clusters.

2. The method of claim 1, wherein the carrying fluid is aqueous and the binding liquid is hydrophobic.

3. The method of claim 1, wherein the agglomerant aid comprises a viscoelastic surfactant in a micellar dispersion to viscosify the carrying fluid during the injection and wherein the viscoelastic surfactant is converted to a free fatty acid form in the activation to generate the binding liquid.

4. The method of claim 1, wherein the carrying fluid comprises an oil-in-water emulsion and the agglomerant aid is activated by destabilizing the emulsion.

5. The method of claim 1, wherein the carrying fluid comprises an oil-in-water emulsion stabilized with a surfactant during the injection and destabilized in the fracture by changing a pH of the carrying fluid to activate the agglomerant aid.

6. The method of claim 1, wherein the activation of the agglomerant aid comprises changing a pH of the carrying fluid.

7. The method of claim 1, wherein a pH of the carrying fluid is high during the injection and lowered in the activation by releasing an acid.

8. The method of claim 1, wherein the treatment slurry stage comprises an ester wherein an acid is released to activate the agglomerant aid by hydrolysis of the ester.

9. The method of claim 1, wherein the treatment slurry stage comprises an encapsulated acid or acid precursor which is released to activate the agglomerant aid.

10. The method of claim 1, wherein the treatment slurry stage further comprises wax coated citric acid which is released by melting the wax in the fracture to activate the agglomerant aid.

11. The method of claim 1, wherein the agglomerant has an aspect ratio higher than 6 and the solid particulate has an aspect ratio less than 6.

12. The method of claim 1, wherein the agglomerant is a fiber, a flake, a ribbon, a platelet, a rod, or a combination thereof.

13. The method of claim 1, wherein the agglomerant is a degradable material.

14. The method of claim 1, wherein the agglomerant is selected from the group consisting of polylactic acid, polyester, polycaprolactam, polyamide, polyglycolic acid, polyterephthalate, cellulose, wool, basalt, glass, rubber, sticky fiber, or a combination thereof.

15. The method of claim 1, wherein the treatment slurry is a proppant-laden hydraulic fracturing fluid and the solid particulate is the proppant.

16. The method of claim 1, wherein the mixture distributed in the fracture comprises a substantially uniform distribution of one or more of the solid particulate, the agglo(original) merant and the agglomerant aid.

17. The method of claim 1, wherein the mixture distributed in the fracture comprises a substantially uniform distribution of one or more of the solid particulate, the agglomerant, the agglomerant aid and an agglomerant aid activator.

18. The method of claim 1, wherein the mixture distributed in the fracture comprises a substantially uniform distribution of the solid particulate, and a heterogeneous distribution of one or more of the agglomerant and the agglomerant aid.

19. The method of claim 1, wherein the mixture distributed in the fracture comprises a substantially uniform distribution of the solid particulate, and a heterogeneous distribution of at least one of the agglomerant, the agglomerant aid and the agglomerant aid activator.

20. A composition, comprising:
a carrying fluid;
a plurality of solid particulates;
an agglomerant having an aspect ratio higher than an aspect ratio of the solid particulates; and
a delayed agglomerant aid comprising a releasable binding liquid or a precursor of a binding liquid;
wherein the composition is capable of transforming via coalescence of the binding liquid from a first state of having a substantially uniform distribution of one or more of the solid particulate, the agglomerant and the agglomerant aid, to a second state comprising clusters rich in the solid particulates and regions that are substantially free of the solid particulates.

21. The composition of claim 20, wherein the clusters that are rich in solid particulates comprise a matrix of the agglomerant and binding liquid filled with the solid particulates.

22. The composition of claim 20, wherein the agglomerant is a fiber, a flake, a ribbon, a platelet, a rod, or a combination thereof.

23. The composition of claim 20, wherein the treatment slurry is a proppant-laden hydraulic fracturing fluid and the solid particulate is a proppant.

24. The composition of claim 20, wherein the solid particulate is present in the treatment slurry in an amount of less than 22 vol %.

25. The composition of claim 20, wherein the agglomerant is present in the treatment slurry in an amount of less than 5 vol %.

26. The composition of claim 20, wherein the viscosity of the carrying fluid is from 10 Pa·s to 500 Pa·s at the range of shear rates 0.001-0.1 s−1 when transforming the composition from the first to the second state.

27. The composition of claim 20, further comprising an activator to activate the agglomerant aid.

28. The composition of claim 20, further comprising a substantially uniform distribution of one or more of the solid particulate, the agglomerant and the agglomerant aid.

29. The composition of claim 20, further comprising an activator to activate the agglomerant aid, and a substantially uniform distribution of one or more of the solid particulate, the agglomerant and the agglomerant aid activator.

30. The composition of claim 20, further comprising a substantially uniform distribution of the solid particulate, and a heterogeneous distribution of one or more of the agglomerant and the agglomerant aid.

31. The composition of claim 20, further comprising an activator to activate the agglomerant aid, a substantially uniform distribution of the solid particulate, and a heterogeneous distribution of one or more of the agglomerant, the agglomerant aid and the agglomerant aid activator.

32. A method of designing a treatment, comprising:
considering a fracture dimension;
selecting an agglomerant having a dimension comparable to the fracture dimension;
selecting a solid particulate having a substantially different settling velocity from the agglomerant;
selecting an agglomerant aid to release a binding liquid to facilitate binding of the solid particulate and the agglomerant;
formulating a treatment fluid comprising the solid particulate, the agglomerant and the agglomerant aid such that the binding liquid is capable of coalescing in the fracture to form clusters of the solid particulate, and to form regions between the clusters that are substantially free of the solid particulate.

33. A system to form conductive channels in a fracture, comprising:
a subterranean fracture having a fracture width;
a treatment fluid placed in the fracture above a fracturing pressure and comprising:
a carrying liquid;
an agglomerant having a dimension comparable to the fracture width;
a solid particulate having a substantially different settling velocity from the agglomerant; and
a delayed agglomerant aid to release a binding liquid which is immiscible with the continuous phase of the carrier fluid, thus facilitating binding of the solid particulate and the agglomerant;
wherein the treatment fluid in the fracture comprises a substantially uniform distribution of the solid particulate, and a heterogeneous distribution of at least one of the agglomerant, the agglomerant aid and an agglomerant aid activator, such that the binding liquid is capable of coalescing in the fracture to form clusters of the solid particulate and regions between the clusters that are substantially free of the solid particulate.

34. A method for diversion treatment comprising:
providing a treatment fluid comprising a blend of low aspect ratio solid particulates, a high aspect ratio agglomerant, and a delayed agglomerant aid, the blend including a first amount of particulates having a first average particle size between about 3 mm and 2 cm and a second amount of particulates having a second average size between about 1.6 and 20 times smaller than the first average particle size or a second amount of flakes having a second average size up to 10 times smaller than the first average particle size;
introducing the treatment fluid into the well bore; and,
creating a plug with said treatment fluid.

35. The method of claim 34, wherein the blend comprises a degradable material, a soluble material, or a meltable material at downhole conditions.

36. The method of claim 35, wherein the degradable material is a polylactic acid material.
